(19) United States
(12) Patent Application Publication
(10) Pub. No.: US 2017/0025739 A1
(43) Pub. Date: Jan. 26, 2017

(54) ANTENNA MODULE, ANTENNA AND MOBILE DEVICE COMPRISING SUCH AN ANTENNA MODULE

(71) Applicant: THE ANTENNA COMPANY INTERNATIONAL N.V., Netherlands Antilles (NL)

(72) Inventors: Diego CARATELLI, Duizel (NL); Francesco GIUPPI, The Hague (NL)

(21) Appl. No.: 15/113,547

(22) PCT Filed: Jan. 22, 2015
(86) PCT No.: PCT/NL2015/050039

§ 371 Date: Jul. 22, 2016

(30) Foreign Application Priority Data
Jan. 24, 2014 (NL) 2012131
Dec. 10, 2014 (NL) 2013951

(51) Int. Cl. H01Q 1/24; H01Q 1/48; H01Q 1/38

(52) U.S. Cl. CPC H01Q 1/243; H01Q 1/38; H01Q 1/48

(57) ABSTRACT

The invention relates to an antenna module, in particular for use in a mobile device, such as a phone. The invention relates to an antenna, in particular for use in a mobile device, such as a phone, comprising at least one antenna module according to the invention. The invention also relates to a mobile device comprising at least one antenna according to the invention. The invention further relates to a method for manufacturing of an antenna according to the invention.

The invention relates to an antenna module, in particular for use in a mobile device, such as a phone. The invention relates to an antenna, in particular for use in a mobile device, such as a phone, comprising at least one antenna module according to the invention. The invention also relates to a mobile device comprising at least one antenna according to the invention. The invention further relates to a method for manufacturing and assembling of an antenna according to the invention.

Because there are many different types of communication systems, such as GSM, DCS, PCS, DAMPS, and others, it is increasingly possible to have different types of systems serving a common area. These systems typically operate at different frequency ranges, e.g. GSM typically operates at 890-960 MHZ and DCS typically operates at 1710-1880 MHZ. Multiple mode antennas, being an antenna which can resonate at different frequencies to allow a communication device to operate in multiple bands, is often applied. The known antenna suffers from several drawbacks. The antennas consume fairly high battery power due to losses caused by lower efficiency and less modest impedance matching. Moreover, the known antennas take more space than desired and required.

A first object of the invention is to provide an improved antenna module for an antenna, in particular for mobile devices, such as mobile (smart)phones.

The present invention overcomes the above-described problems, and achieves additional advantages, by providing an antenna according to claim 1. The antenna module according to the invention constitutes an antenna component to be combined with a ground plane to form an antenna, which is ideally suitable to be applied in mobile devices, such as phones. The ground plane may be formed by a conductive plate or conductive element making part of the mobile device. By mounting or attaching the antenna module—commonly as separate component—onto and/or within said mobile device in such as manner that the conductive plate or element may act as ground plane, the mobile device can efficiently be provided with a very compact, high-performance antenna. To this end, the antenna module is preferably positioned on top of conductive plate or element acting as ground plane, wherein the ground plane and the branches and feeding line(s) are physically separated by the dielectric substrate, and eventually by an additional insulating layer, such as an air gap.

This application claims priority to Dutch patent application No. 2012131, filed on Jan. 24, 2014, and to Dutch patent application No. 2013951, filed on Dec. 10, 2014, the disclosures of which are herein incorporated by reference.

The antenna module according to the invention is configured to form—together with a ground plane—a multiple band, multiple branch antenna which can be tuned to multiple resonant frequencies. Due to the meander shaped branch the antenna module is relatively compact which makes the antenna module ideally suitable to incorporate in mobile (portable) devices, such as (smart)phones or tablets. The multiple resonances for the antenna (corresponding to, for example, Wi-Fi, GSM, DCS, LTE, WCDMA, or PCS) are achieved by providing variations in the printed pattern of the antenna branches. Preferably, the meander shaped branch (longest branch) is designed to operate within a relatively low frequency band, in particular the GSM band (890-960 MHz), while the at least one additional branch (short branch) is designed to operate within at least one relatively high frequency band, in particular the DCS/PCS band (1710-1880/1850-1990 MHz), an WLAN frequency band (2400-2484 MHz), or an LTE frequency band (e.g. 1800 and 2600 MHz). The branches are used to improve the impedance matching of the antenna by exciting additional resonance processes in specific frequency bands of the device. The application of multiple branches, preferably multiple additional branches, in particular multiple side branches of the meander shaped branch, are favourable for improving the performance of the antenna in terms of return loss and number of operational frequency bands.

Embodiments of the antenna according to the invention will be described below in the description and in the dependent claims.

The dielectric support substrate is preferably formed a printed circuit board (PCB). This PCB may also be a carrier of (other) electrical circuits related to a mobile device, such as a phone, tablet, or laptop, in which the antenna module is mountable. The PCB commonly has a flat orientation and is often provided with one or more screw holes to facilitate mounting of the antenna module in or onto the mobile device. The PCB are often formed by a laminate manufactured by curing under pressure and temperature layers of cloth or paper with thermoset resin to form an integral final piece of uniform thickness. Varying cloth weaves (threads per inch or cm), cloth thickness, and resin percentage are used to achieve the desired final thickness and dielectric characteristics. Instead of said typical PCB material, the dielectric substrate may also at least partially be made of a polymer, in particular a fibre reinforced polymer. A suitable polymer is poly(propylene oxide) (PPO) having a relative dielectric constant (∈ᵣ) of about 4. Reinforcement of this polymer can be achieved by adding glass fibres which leads to a composite material. Alternative dielectric composite materials to be used for manufacturing the substrate are also imaginable.

The branches are preferably printed onto the support substrate using known techniques. Commonly, the branches are made of conductive material, preferably metal, more preferably copper. By way of printing, a branch pattern can easily and with high accuracy be realised onto a surface of the support substrate. Other techniques, such as etching, may also be applicable, though are commonly more complicated and expensive, and hence less preferred. Preferably, the branches have a substantially flat geometry. The branches are commonly formed by thin tracks which are mutually connected. A typical thickness of the branches is between 10 and 40 micron. Preferably, the outer width of the meander shaped branch is between 0.8 and 1 cm. The outer length of the meander shaped branch is preferably between 1 and 2 cm. The total length of the meander shaped branch as such is preferably between 5 and 15 cm. The width of the meander shaped branch as such is preferably between 0.25 and 1.5 mm. The geometries of the branches can be varied to allow increased design freedom.

Preferably, the branches are situated in a common plane. The same applies to the feeding inlet(s), which is/are preferably also positioned in the same common plan. In this case, a single surface of the dielectric support substrate will be covered by the branches (and feeding inlet(s)), which facilitates mounting and installation of the antenna module as such.

Preferably, the at least one additional branch, commonly acting as a high frequency control arm, is a side branch of the meander shaped branch. Alternatively, the at least one additional branch is a side branch of one or multiple feeding inlets. A combination of both embodiments is also conceivable. The antenna performance may be improved further by applying multiple additional branches are applied. In this latter case, preferably at least two additional branches are connected to opposite sides of the meander shaped branch in order to achieve the best performance improvement. The multiple branch antenna (module) of the present invention achieves resonance at different frequencies without a matching network. If the antenna branches are formed by printing, mechanical tolerance problems are avoided.

Preferably, the meander shaped branch has a first length and first cross-sectional geometry for resonating at a first frequency, while the at least one additional branch has a second length and second cross-sectional geometry for resonating at a second frequency. Of course, the dimensioning of the branches is preferably chosen in such a way that the branches will be suitable to operate in a desired frequency band. The first and second cross-sectional geometries may be substantially similar. More in particular, the first and second cross-sectional geometries are preferably substantially cylindrical, and have diameters selected to achieve a desired bandwidth and size.

Each branch may include a flexible dielectric film having a different metal strip line pattern formed thereon.

Although the branches are commonly situated in a common plane leading to a 2D-configuration of the branches, it is also imaginable that the branches individually or considered together have a more spatial, 3D-configuration. Both implementations are possible, depending on the requirements on the volume occupation of the antenna and on possible constraints in the integration with host platforms.

Preferably, also at least a part of the at least one feeding line is printed onto the substrate for the same reasons as given above. The geometry of the at least one feeding line is decisive for the resonance frequency. It could be very favourable to apply multiple feeding lines attached to said substrate. All feeding lines are preferably connected to at least one common (collective) meander shaped branch. Preferably, at least two feeding lines have a mutually different input impedance level and/or are configured to have mutually different resonance behaviour. This allows a single antenna comprising such a multi-feed (multi-port) antenna module to operate (simultaneously) at different frequency bands. This antenna construction could realize a gain up to 4 dB representative for two times better than conventional antennas), and could increase the antenna efficiency up to 65%. This would improve conversation quality (in the GSM band) and would increase data transfer speed due to extended radio coverage. To achieve this multiband coverage, it is preferable that the at least two feeding lines have mutually different geometries, in particular mutually different lengths, thicknesses, widths, and/or conductivities.

The antenna module preferably comprises at least one dielectric housing enclosing said branches at least substantially. The dielectric housing protects the branches from mechanical damage, and moreover prevents the branches from oxidation. Furthermore, this dielectric housing acts as resonator and/or as lens, and its geometry influences the radiation pattern and the antenna performance, which moreover allows the antenna module as such to be miniaturized. Hence, application of the at least one dielectric housing provides more freedom of design of the antenna module, as a result of which an optimum antenna module design for a specific application could more easily be realized. The at least one feeding inlet is preferably substantially positioned outside the dielectric housing. A feeding inlet is commonly connected to a power source during installation and is therefore preferably left uncovered at least partly.

The dielectric housing preferably comprises multiple housing sections, wherein at least one first housing section encloses the meander shaped branch at least substantially, and wherein at least one second housing section encloses the additional branch at least substantially. In this case, the geometry of each housing section can be optimized for its specific radiation purpose. In this context, it is conceivable that the first housing section and the at least one second housing section are made of mutually distinctive dielectric materials. Furthermore, it is preferable that each additional branch is enclosed by a second housing section.

The dielectric housing is preferably at least partially made of a material chosen from the group consisting of: a polymer, alumina, silicon, GaAs, a semiconductor, and a ceramic material. In a particular preferred embodiment the dielectric housing is at least partially made of a composite polymer, comprising at least one non-polymeric additive, such as for example PPO reinforced with glass fibres. # Preferably, the dielectric permittivity of the dielectric housing is between 6 and 18, which has shown to give the best antenna performance. Although the dimensioning the dielectric housing may vary, the width of the dielectric housing is preferably between 0.8 and 1 cm. The length of the dielectric housing is preferably between 1 and 2 cm. In a preferred embodiment, the distance between an upper surface of the housing facing away from the support substrate, and a surface of the meander shaped branch facing away from the support substrate, is between 0.99 and 2 cm.

The number of curves of the meander shaped branch is at least 4. This minimum number of curves is preferably, since this will provide the best antenna results, while keeping the antenna module as compact as possible. Smooth curves will commonly contribute to the realisation of a relatively homogeneous radiation pattern. Furthermore, a free end of at least one branch preferably has a tapered shape.

The distance between two closest sections of the meander shaped branch is preferably between 0.1 and 1 mm. This allows the meander shaped branch to be shaped as compact as possible without creating a short circuit between distal sections. The number of additional branches is at least one, though could be more additional branches, typically between 2 and 6, could be applied for specific applications.

The invention also relates to an antenna, comprising: at least one antenna module according to the invention, and at least one conductive plate acting as ground plane, positioned at a side of the dielectric substrate opposite to the branches of the antenna module. Commonly, the (substantially planar) dielectric substrate and the (substantially planar) ground plane are positioned substantially parallel. The dielectric substrate and the ground plane are preferably attached to each other. In an alternative embodiment, the dielectric substrate and the ground plane are positioned at a distance from each other, and mutually enclose a (dielectric) air space or air gap. The ground plane, commonly formed by a conductive plate, a conductive plate-like element may make part of a mobile device, such as a phone. Eventually, a conductive casing of the mobile device could also act as ground plane.

The invention further relates to a mobile communication device, in particular a phone, tablet, or laptop, comprising one or more antennas according to the invention. Preferably, the mobile device comprising: transceiver circuitry for exchanging communication signals in multiple modes; and a single port for interfacing between the transceiver circuitry and a multiple mode antenna, the multiple mode antenna comprising a meander shaped branch having a first length and first cross-sectional geometry for resonating at a first frequency in a first mode, and at least one additional branch having a second length and second cross-sectional geometry for resonating at a second frequency in a second mode.

The invention further relates to a method for manufacturing of an antenna module according to the invention, comprising the step of: A) attaching, preferably depositing or printing, a feeding inlet, at least one meander shaped branch, and at least one additional branch onto a dielectric supporting substrate. The method preferably also comprises step B) consisting of encapsulating, preferably by moulding, the branches at least substantially by a dielectric housing, preferably a polymer comprising housing. The deposition process according to step A) is preferably carried out by mean of a photolithographic, a galvanization, and/or a (3D) printing process.

The invention moreover relates to a method of assembling an antenna according to the invention, comprising the step of combining an antenna module according to the invention, and at least one conductive plate or plate-like element acting as ground plane. The conductive plate could make part of a mobile device, wherein the antenna module is mounted within a casing of said mobile device to form the actual antenna.

The antenna according to the invention as well as the technical effect of said antenna are further elucidated on the basis of non-limitative exemplary embodiments shown in the enclosed figures.

Herein:

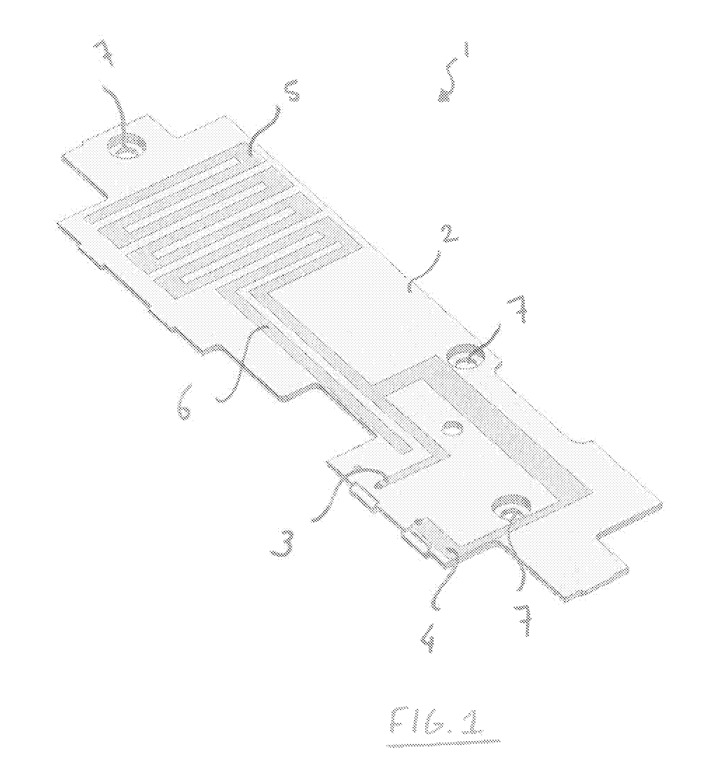

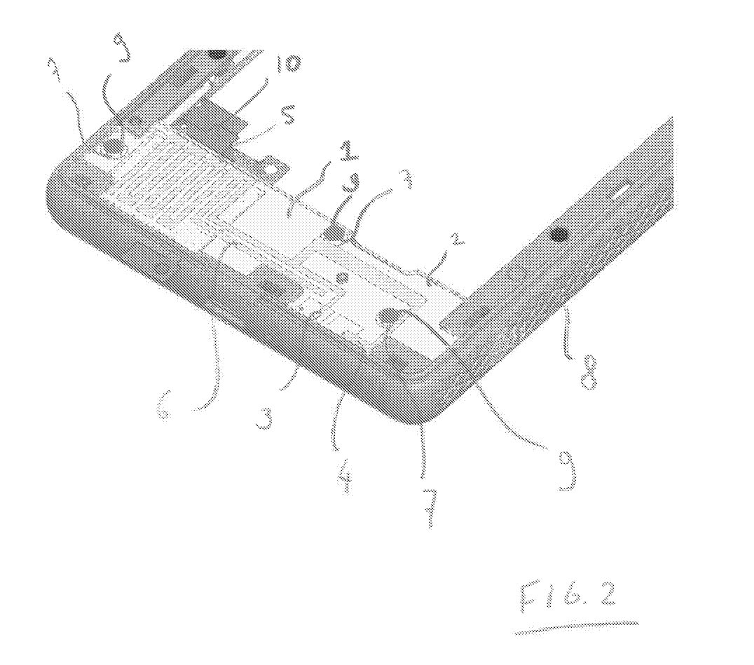

FIG. 1 shows schematically an antenna module according to a first embodiment of the invention;

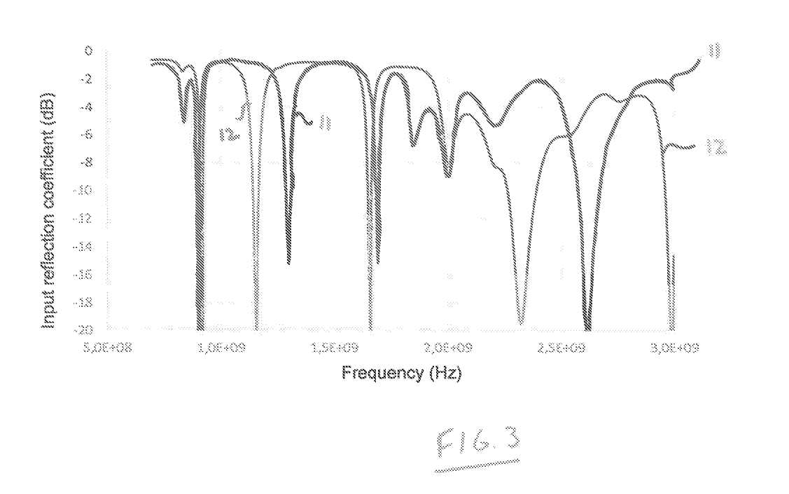

FIG. 2 shows schematically the antenna module of FIG. 1, placed in a mobile device;

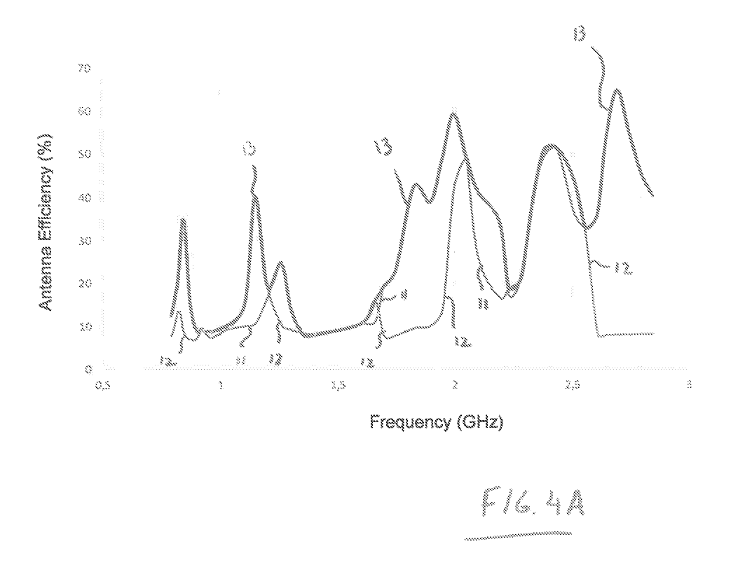

FIG. 3 schematically shows the input reflection coefficient (in dB) of two different antenna ports, corresponding to two different feeding lines.

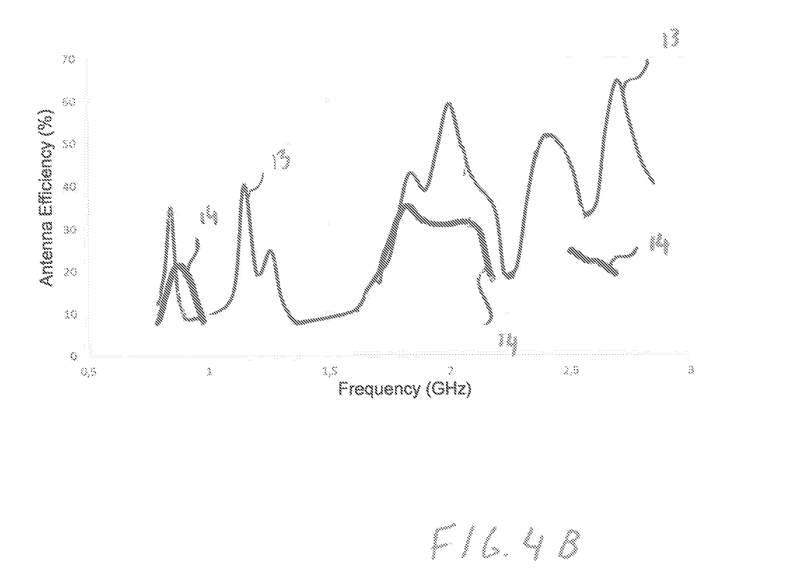

FIG. 4A shows the antenna efficiency (in %) of the two antenna ports of FIG. 3, as well as the combined ports which combines the two antenna ports;

FIG. 4B shows the combined antenna efficiency (in %) of the two antenna ports compared to the efficiency of an antenna used in the art;

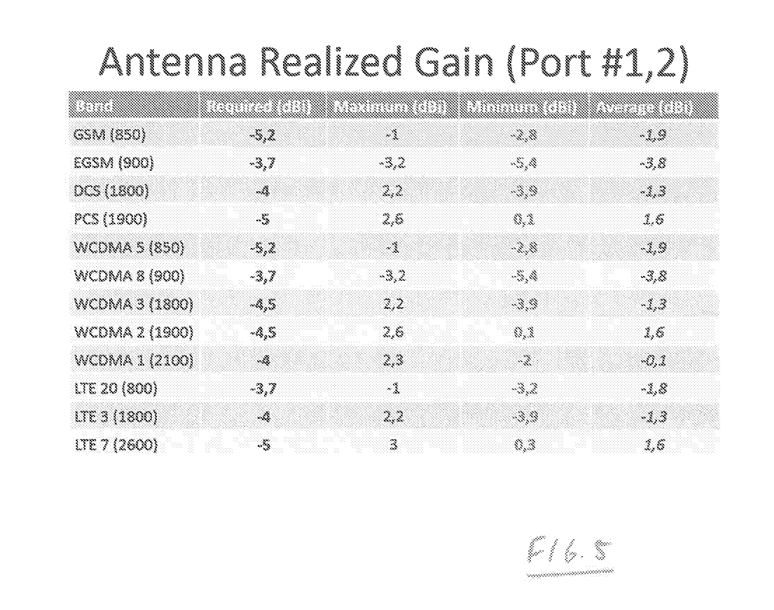

FIG. 5 shows the realized gain of the antenna with the two ports of FIGS. 3 and 4; and

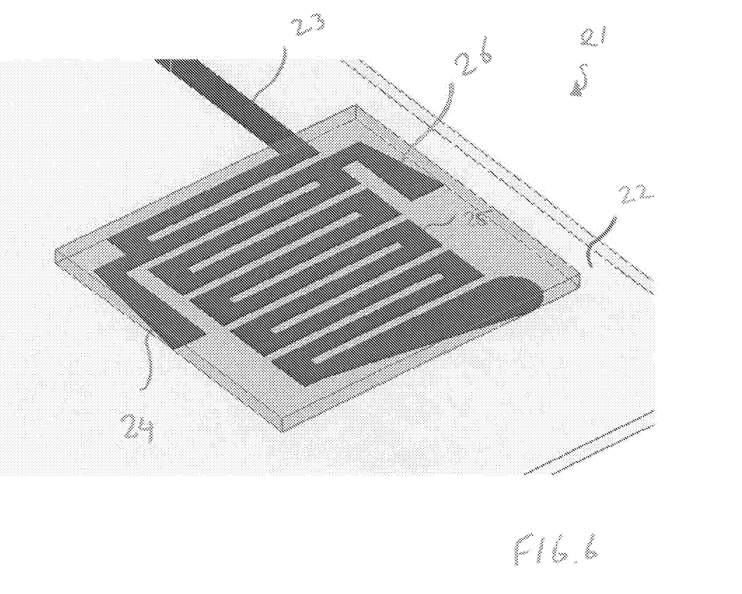

FIG. 6 schematically shows an antenna module according to a second embodiment of the present invention

FIG. 1 shows schematically an antenna module (1) according to a first embodiment of the invention, comprising a dielectric support substrate (2), two feeding lines (3, 4) attached to said substrate (2), a meander shaped branch (5) connected to said feeding line (3, 4) and attached to said substrate (2), and an additional resonant branch (6) connected to said feeding line (3, 4) and attached to said substrate (2). The antenna module (1) is for instance used in a (non-shown) mobile device. To attach the module (1) to the (non-shown) mobile device, the substrate (2) can be provided with three holes (7), through which for instance screws can be inserted.

The substrate (2) is for instance a composite material composed of woven fiberglass cloth with an epoxy resin binder that is flame resistant, with a thickness of about 0.5 mm. The substrate (2) is typically a printed circuit board (2), for instance one that is part of the (non-shown) mobile device. The feeding lines (3, 4) and the meander shaped branch (5) are typically made of a metal trace (5), such as copper.

The meander shaped branch (5) the antenna is relatively compact which makes the antenna module (1) ideally suitable to incorporate in mobile (portable) devices, such as (smart)phones or tablets.

The feeding lines (3, 4) of the module (1) are different from each other, such that one (3) has different dimension such as length or thickness compared to the other (4). In the shown embodiment feeding line (3) is thinner and shorter compared to the other feeding line (4). This results in different input impedances of the two feeding lines (3, 4), and thus to different resonant frequencies in the resonant branch (6). This effectively results in a better tuning of the antenna module (1) to different bandwidths used for instance in mobile telephony. One feeding line (3) may for instance be tunes for optimal functionality at GSM frequency bands of 850 MHz, whereas the other feeding line (4) may be tuned for optimal functionality at WCDMA (Wideband Code Division Multiple Access) or LTE (Long-Term Evolution) frequencies.

The tuning to different frequencies can also be achieved by having multiple resonant branches which differ in dimensions connect to the feeding line (3).

FIG. 2 shows schematically the antenna module (1) of FIG. 1, placed in a mobile device (8). The module (1) is attached to the mobile device (8) by three screws (9), inserted in holes (7) in the substrate (2). The mobile device (8) is further provided with a conductive plate (10) acting as a ground plane (10). The substrate (2) is, in this configuration attached to the ground plane (10).

FIG. 3 schematically shows the input reflection coefficient (in dB) of two different antenna ports (11, 12), corresponding to two different feeding lines. The two ports (11, 12) are tunes for the frequency bands of GSM (850 MHz), WCDMA (850, 900, 1800, 1900, 2100 MHz) and LTE (800, 1800, 2600 MHz).

The first antenna port (11) shows decreased input reflection (in dB) around multiple frequencies, such as:
800 MHz-850 MHz, (LTE20, WCDMA 5, and GSM)
1.3 GHz
1.7 GHz
1.9 GHz (DCS, WCDMA 3, LTE 3)
2.0 GHz (WCDMA 2, PCS)
2.2 GHz (WCDMA 1)
2.6 GHz (LTE 7)

The second antenna port (12) shows decreased input reflection (in dB) around multiple frequencies, such as:
800 MHz-850 MHz, (LTE20, WCDMA 5 and GSM)
1.15 GHz
1.65 GHz
2.0 GHz (PCS, WCDMA 2)
2.2 GHz (WCDMA 1)
2.3 GHz
3.0 GHz

FIG. 4A shows the antenna efficiency (in %) of the two antenna ports (11, 12) of FIG. 3, as well as the combined ports (13) which combines the two antenna ports (11, 12). The combination of the two antenna ports (11, 12) combines the efficiency of both individual antenna ports (11, 12).

FIG. 4B shows the combined (13) antenna efficiency (in %) of the two antenna ports (11, 12) compared to the efficiency of an antenna (14) used in the art, in this case in a Samsung mobile phone indicated as “Galaxy S4”. With the exception of the frequency band around 900 MHz, the antenna has a much higher efficiency compared to the known antenna.

FIG. 5 shows the realized gain of the antenna with the two ports (11, 12) of FIGS. 3 and 4. With the exception of the frequencies at 900 MHz for EGSM and WCDMA 8, all frequency bands show a minimal measures dBi which exceeds the required value. On average the frequencies at 900 MHz are close to or almost the same as the required values. The combination of the two antenna ports (11, 12) thus results in excellent antenna characteristics in terms of gain and efficiency.

FIG. 6 schematically shows an antenna module (21) according to a second embodiment of the present invention, comprising a dielectric support substrate (22), a feeding lines (23) attached to said substrate (22), a meander shaped branch (25) connected to said feeding line (23) and attached to said substrate (22), and two additional resonant branches (24, 26) connected to said feeding line (23) and attached to said substrate (22). The antenna module (21) is for instance used in a (non-shown) mobile device.

The resonant branches (24, 26) of the module (21) are different from each other, such that one (24) has different dimension such as length or thickness compared to the other (26). In the shown embodiment branch (26) is smaller compared to the other branch (24). This results in different input impedances of the two resonant branches (24, 26).

The two branches (24, 26) can be tuned to specific frequency bands just as in the first embodiment of the present invention.

It will be apparent that the invention is not limited to the exemplary embodiments shown and described here, but that within the scope of the appended claims numerous variants are possible which will be self-evident to the skilled person in this field.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Inventive concepts are illustrated in a series of examples, some examples showing more than one inventive concept. Individual inventive concepts can be implemented without implementing all details provided in a particular example. It is not necessary to provide examples of every possible combination of the inventive concepts provide below as one of skill in the art will recognize that inventive concepts illustrated in various examples can be combined together in order to address a specific application.

Other systems, methods, features and advantages of the disclosed teachings will be or will become apparent to one with skill in the art upon examination of the following figures and detailed description. It is intended that all such additional systems, methods, features and advantages be included within the scope of and be protected by the accompanying claims.

1. Antenna module, in particular for use in a mobile device, such as a phone, comprising:
at least one dielectric support substrate
at least one feeding line attached to said substrate,
at least one meander shaped branch connected to said feeding line and attached to said substrate, and
at least one additional resonant branch connected to said feeding line and/or said meander shaped branch, and attached to said substrate.

2. Antenna module according to claim 1, wherein the dielectric support substrate is a printed circuit board (PCB).

3. Antenna module according to claim 2, wherein the printed circuit board makes part of a mobile device, such as a phone.

4. Antenna module according to one of the foregoing claims, wherein the dielectric substrate is at least partially made of a polymer, in particular a fibre reinforced polymer.

5. Antenna module according to one of the foregoing claims, wherein the branches are printed onto the support substrate.

6. Antenna module according to one of the foregoing claims, wherein the branches have a substantially flat geometry.

7. Antenna module according to one of the foregoing claims, wherein the branches are situated in a common plane.

8. Antenna module according to one of the foregoing claims, wherein the at least one additional branch is a side branch of the meander shaped branch.

9. Antenna module according to one of the foregoing claims, wherein multiple additional branches are applied.

10. Antenna module according to claims 8 and 9, wherein at least two additional branches are connected to opposite sides of the meander shaped branch.

11. Antenna module according to one of the foregoing claims, wherein at least a part of the at least one feeding line is printed onto the substrate.

12. Antenna module according to one of the foregoing claims, wherein the antenna module comprises multiple feeding lines attached to said substrate.

13. Antenna module according to claim 12, wherein the feeding lines are connected to at least one common meander shaped branch.

14. Antenna module according to claim 12 or 13, wherein, the at least two feeding lines have a mutually different input impedance level.

15. Antenna module according to one of claims 12-14, wherein, the at least two feeding lines are configured to have mutually different resonance behaviour.

16. Antenna module according to claim 14 or 15, wherein, the at least two feeding lines have mutually different lengths and/or widths.

17. Antenna module according to one of the foregoing claims, wherein the antenna module comprises at least one dielectric housing enclosing said branches at least substantially.

18. Antenna module according to claim 17, wherein the at least one feeding inlet is substantially positioned outside the dielectric housing.

19. Antenna module according to claim 17 or 18, wherein the housing comprises multiple housing sections, wherein at least one first housing section encloses the meander shaped branch at least substantially, and wherein at least one second housing section encloses the additional branch at least substantially.

20. Antenna module according to claim 19, wherein the first housing section and the at least one second housing section are made of mutually distinctive dielectric materials.

21. Antenna module according to claim 19 or 20, wherein each additional branch is enclosed by a second housing section.

22. Antenna module according to one of the claims 17-21, wherein the dielectric housing is at least partially made of a material chosen from the group consisting of: a polymer, alumina, silicon, GaAs, a semiconductor, and a ceramic material.

23. Antenna module according to claim 22, wherein the dielectric housing is at least partially made of a composite polymer, comprising at least one non-polymeric additive.

24. Antenna module according to one of the claims 17-23, wherein the dielectric permittivity of the dielectric housing is between 6 and 18.

25. Antenna module according to one of the claims 17-24, wherein the width of the dielectric housing is between 0.8 and 1 cm.

26. Antenna module according to one of the claims 17-25, wherein the length of the dielectric housing is between 1 and 2 cm.

27. Antenna module according to one of the claims 17-26, wherein the width of the dielectric housing is between 0.5 and 1 mm.

28. Antenna module according to one of the claims 17-27, wherein the distance between an upper surface of the housing facing away from the support substrate, and a surface of the meander shaped branch facing away from the support substrate, is between 0.99 and 2 cm.

29. Antenna module according to one of the foregoing claims, wherein at least one additional branch has a substantially linear orientation.

30. Antenna module according to one of the foregoing claims, wherein the antenna is configured to operate in at least one of the following bandwidths: the Cellular GSM, LTE, WCDMA, and/or Wi-Fi.

31. Antenna module according to one of the foregoing claims, wherein each branch is made of a conductive material, preferably a metal, in particular copper.

32. Antenna module according to one of the foregoing claims, wherein the number of curves of the meander shaped branch is at least 4.

33. Antenna module according to one of the foregoing claims, wherein the meander shaped branch comprises substantially smooth curves.

34. Antenna module according to one of the foregoing claims, wherein a free end of at least one branch has a tapered shape.

35. Antenna module according to one of the foregoing claims, wherein the outer width of the meander shaped branch is between 0.8 and 1 cm.

36. Antenna module according to one of the foregoing claims, wherein the outer length of the meander shaped branch is between 1 and 2 cm.

37. Antenna module according to one of the foregoing claims, wherein the total length of the meander shaped branch as such is between 5 and 15 cm.

38. Antenna module according to one of the foregoing claims, wherein the width of the meander shaped branch as such is between 0.25 and 1.5 mm.

39. Antenna module according to one of the foregoing claims, wherein the thickness of the meander shaped branch is between 10 and 40 micron.

40. Antenna module according to one of the foregoing claims, wherein the distance between two closest sections of the meander shaped branch is between 0.1 and 1 mm.

41. Antenna module according to one of the foregoing claims, wherein the number of additional branches is between 2 and 6.

42. Antenna module according to one of the foregoing claims, wherein the antenna comprises multiple meander shaped branches which are at least substantially enclosed by the dielectric housing.

43. Antenna module according to one of the foregoing claims, wherein the dielectric substrate is substantially block shaped.

44. Antenna, comprising:
at least one antenna module according to one of the foregoing claims, and
at least one conductive plate acting as ground plane, positioned at a side of the dielectric substrate opposite to the branches of the antenna module.

45. Antenna, according to claim 44, wherein the dielectric substrate and the ground plane are positioned parallel.

46. Antenna according to claim 44 or 45, wherein the dielectric substrate and the ground plane are attached to each other.

47. Antenna according to claim 44 or 45, wherein the dielectric substrate and the ground plane are positioned at a distance from each other, and mutually enclose an air space.

48. Antenna according to one of claims 44-47, wherein the ground plane makes part of a mobile device, such as a phone.

49. Mobile device, in particular a phone, comprising at least one antenna according to one of claims 44-48.

50. Mobile device according to claim 49, comprising: transceiver circuitry for exchanging communication signals in multiple modes; and a single port for interfacing between the transceiver circuitry and a multiple mode antenna, the multiple mode antenna comprising a meander shaped branch having a first length and first cross-sectional geometry for resonating at a first frequency in a first mode, and at least one additional branch having a second length and second cross-sectional geometry for resonating at a second frequency in a second mode.

51. Method for manufacturing of an antenna module according to one of claims 1-43, comprising the step of:
A) attaching, preferably depositing, a feeding inlet, at least one meander shaped branch, and at least one additional branch onto a dielectric supporting substrate.

52. Method according to claim 51, wherein the method further comprises step B), consisting of encapsulating, preferably by moulding, the branches at least substantially by a dielectric housing, preferably a polymer comprising housing.

53. Method according to any of claims 50-52, wherein the deposition process according to step A) is carried out by mean of a photolithographic and/or a galvanization process.

54. Method of assembling an antenna according to one of claims 44-48, comprising the step of combining an antenna module according to one of claims 1-43, and at least one conductive plate acting as ground plane.

55. Method according to claim 54, wherein the conductive plate makes part of a mobile device, and the antenna module is mounted within a casing of said mobile device.
